(19) United States
(12) Patent Application Publication
(10) Pub. No.: US 2016/0004338 A1
(43) Pub. Date: Jan. 7, 2016

(54) STYLUS, SYNCHRONIZATION SYSTEM AND METHOD THEREOF FOR TOUCH DETECTION

(71) Applicant: ILI Technology Corp., Hsinchu County (TW)

(72) Inventor: CHENG-CHUNG HSU, HSINCHU COUNTY (TW)

(21) Appl. No.: 14/490,816

(22) Filed: Sep. 19, 2014

(30) Foreign Application Priority Data
Jul. 2, 2014 (TW) 103122881

(51) Int. Cl. G06F 3/0354; G06F 3/044

(52) U.S. Cl. CPC G06F 3/03545; G06F 3/044

(57) ABSTRACT

A synchronization system for touch detection is provided. The synchronization system includes at least one stylus and a touch device. The at least one stylus includes a signal generator, a first micro control unit and a first communication unit. The first micro control unit couples to the signal generator. The first communication unit couples to the first micro control unit. The signal generator generates at least one output signal. The first micro control unit controls the signal generator according to a regulation signal to regulate the at least one output signal. The first communication unit receives the regulation signal and transmits to the first micro control unit. The touch device receives the at least one output signal, and generates the regulation signal based on the at least one output signal to transmit to the at least one stylus.

### BACKGROUND

1. Technical Field

The present disclosure relates to a stylus for touch detection, in particular, to a stylus, synchronization system and method thereof.

2. Description of Related Art

Recently, the input system has developed touch control with the advances in technology, and the touch device most uses the passive mode. Taking the touch device using the projected capacitance, the driving signal is generated by the control system of the touch device. The user touches the device by the finger or the electrical material to vary the electric charge on the sensing electrodes of the touch device. Thus, the control system of the touch device detects the position of the touch point by the difference between detection signals on the sensing electrodes.

However, the user cannot precisely operate by using the finger. Although the passive stylus or active stylus can remedy the disadvantage of the touch by finger, the flexibility becomes worse since the touch area of the passive stylus is usual less than the touch area of finger; and the signal generated by the active stylus is usual overlapping with the detection signal of the touch device in the same period to cause the signal collision and the interference.

### SUMMARY

An exemplary embodiment of the present disclosure provides a synchronization system for touch detection. The synchronization system includes at least one stylus and a touch device. The at least one stylus includes a signal generator, a first micro control unit and a first communication unit. The first micro control unit couples to the signal generator. The first communication unit couples to the first micro control unit. The signal generator generates at least one output signal. The first micro control unit controls the signal generator according to a regulation signal to regulate the at least one output signal. The first communication unit receives the regulation signal and transmits to the first micro control unit. The touch device receives the at least one output signal, and generates the regulation signal based on the at least one output signal to transmit to the at least one stylus.

An exemplary embodiment of the present disclosure provides a synchronization method for touch detection. The synchronization method comprises the following steps: at least one output signal is generated by a signal generator of at least one stylus, and transmitted to a touch device; a regulation signal is generated based on the at least one output signal by the touch device and transmitted to the at least one stylus; the regulation signal is transmitted to a first micro control unit of the at least one stylus to control the signal generator, to regulate the at least one output signal; and the regulated at least one output signal outputted from the at least one stylus is received by the touch device.

An exemplary embodiment of the present disclosure provides a stylus adapted for a touch device. The at least one stylus includes a signal generator, a micro control unit and a communication unit. The micro control unit couples to the signal generator. The communication unit couples to the micro control unit. The signal generator generates at least one output signal. The micro control unit controls the signal generator according to a regulation signal to regulate the at least one output signal. The communication unit receives the regulation signal and transmits to the micro control unit. Wherein the touch device receives the at least one output signal and generates the regulation signal based on the at least one output signal to transmit to the at least one stylus.

To sum up, the stylus, the synchronization system and the synchronization method for touch detection provided by the present disclosure can establish the synchronization mechanism to avoid the interference in the signal detection between the stylus and the touch device when the touch device detects the touch by finger and the touch by stylus. Additionally, the stylus of the present disclosure can be adapted for each touch device by regulating a report rate and a signal-to-noise ratio (SNR) of an output signal outputted from the stylus. Furthermore, the synchronization system and the method for touch detection of the present disclosure can look upon the stylus or the touch device as the host device to flexibly regulate the signal therebetween, to increase the efficiency between the stylus and touch device supporting the touch by the finger and the stylus at the same time, and even further the efficiency between a plurality of the styluses and the touch device.

In order to further understand the techniques, means and effects of the present disclosure, the following detailed descriptions and appended drawings are hereby referred to, such that, and through which, the purposes, features and aspects of the present disclosure can be thoroughly and concretely appreciated, however, the appended drawings are merely provided for reference and illustration, without any intention that they be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 shows a block diagram of a synchronization system for touch detection of an embodiment according to the present disclosure;

FIG. 2 shows a diagram of the signal collision that occurs when a stylus and a touch device are not synchronous in the embodiment according to the present disclosure;

FIG. 3 shows a diagram of how the touch device regulates a detection signal according to an output signal outputted from the stylus in the embodiment according to the present disclosure;

FIG. 4 shows a diagram of how the stylus and the touch device regulate both the output signal and the detection signal in the embodiment according to the present disclosure;

FIG. 5 shows a diagram of how the stylus and the touch device regulate both the output signal and the detection signal in another embodiment according to the present disclosure;

FIG. 6 shows a flowchart of how the touch device regulates a detection signal according to an output signal outputted from the stylus in the embodiment according to the present disclosure;

FIG. 7 shows a flowchart of how the stylus and the touch device regulate both the output signal and the detection signal in the embodiment according to the present disclosure.

### DESCRIPTION OF THE EXEMPLARY EMBODIMENTS

Reference will now be made in detail to the exemplary embodiments of the present disclosure, examples of which are illustrated in the accompanying drawings.

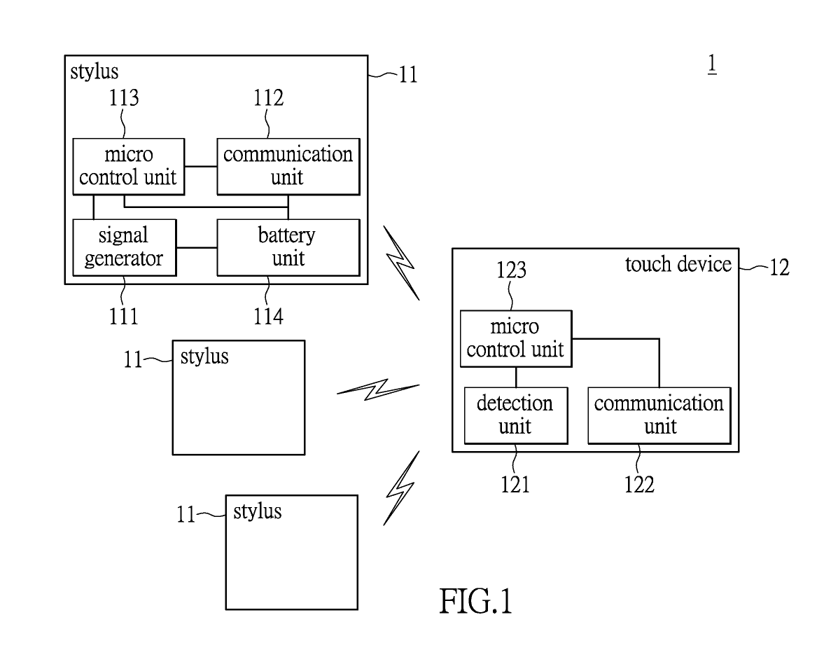

Please refer to FIG. 1. FIG. 1 shows a block diagram of a synchronization system for touch detection of an embodiment according to the present disclosure. The synchronization system 1 for touch detection includes a plurality of styluses 11 and a touch device 12. The stylus 11 includes a signal generator 111, a communication unit 112, a micro control unit 113 and a battery unit 114. The touch device 12 includes a detection unit 121, a communication unit 122 and a micro control unit 123. The micro control unit 113 is coupled to the signal generator 111. The communication unit 112 is coupled to the micro control unit 113. The signal generator 111, the communication unit 112 and the micro control unit 113 are coupled to the battery unit 114. The detection unit 121 and the communication unit 122 are coupled to the micro control unit 123.

In the embodiment of the present disclosure, the stylus 11 is an active stylus. More specifically, the stylus 11 supports the power to signal generator 111 by the battery unit 114, to drive the signal generator 111 generating an output signal.

The signal generator 111 is configured for generating at least one output signal, and the at least one output signal is detected by the touch device 12. For instance, the touch device 12 receives the output signal outputted from the stylus 11, and changes the charge/discharge wave on sensing electrodes located round the touch position on the touch device 12 to form a touch effect by finger. Thus, the touch device 12 determines the touch position of the stylus 11 according to the variance of the charge/discharge wave on sensing electrodes. In the embodiment of the present disclosure, the signal generator 111 can generate the output signal as a wave or a square wave. The signal generator 111 can be a voltage controlled oscillator (VCO).

The communication unit 112 is configured for receiving a control signal from an external part, and further transmits the control signal to the micro control unit 113. The control unit 113 is configured for controlling the signal generator 111, to regulate the output signal generated by the signal generator 111. In detail, the micro control unit 113 controls the signal generator 111 to regulate a period of the output signal and a time length of the output signal. Wherein the output signal comprises a report rate and a signal-to-noise ratio (SNR). The report rate of the output signal is inversely proportional to the period of the output signal, and the signal-to-noise ratio of the output signal is proportional to the period of the output signal.

In the embodiment of the present disclosure, the touch device 12 is configured for co-operating with the at least one stylus 11. As said above, the touch device 12 can be a tablet, a smart phone, or other electronic apparatus including the touch screen.

The detection unit 121 of the touch device 12 is configured for generating at least one detection signal. More specifically, the detection unit 121 generates a plurality of voltage signals in different times to scan sensing electrodes, to detect whether the object touches the touch device 12. It is worth noting that the period of the detection signal is greater than the total length summing the time length of the output signal of the at least one stylus 11 and the time length of the detection signal.

The communication unit 122 of the touch device 12 is configured for transmitting the signal to the at least one stylus 11. More specifically, the touch device 12 further generates the corresponding signal and transmits back to the stylus 11 via the communication unit 122 upon the stylus 11 outputting the output signal to the touch device 12. In other words, the communication units 112, 122 can provide the communication between the stylus 11 and the touch device 12.

The micro control unit 123 of the touch device 12 is configured for generating the regulation signal and controlling the detection unit 121 to regulate the detection signal. In detail, the micro control unit 123 generates the regulation signal above based on the report rate and the signal-to-noise of the output signal upon the touch device 12 that receives the output signal. Additionally, the micro control unit 123 also generates the control signal based on the report rate and the signal-to-noise of the output signal, to control the detection unit 121 regulating the detection signal. It is worth noting that the micro control unit 123 further detects whether the required performance is satisfied between the touch device 12 and the stylus 11 when the touch device 12 and/or the stylus 11 is regulated.

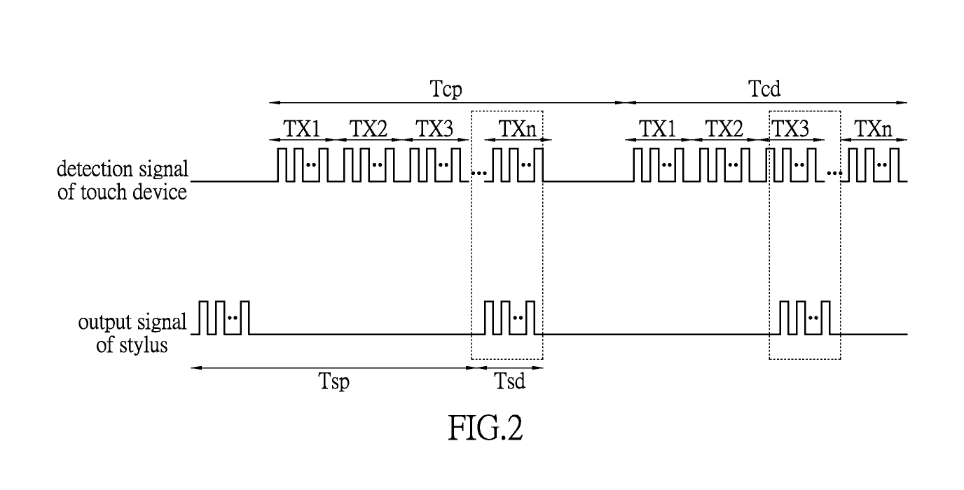

Please refer to FIG. 2. FIG. 2 shows a diagram of the signal collision that occurs when a stylus and a touch device are not synchronous in the embodiment according to the present disclosure. It is worth noting that although the signal wave is a square wave it is not limited to a square wave in the embodiment of the present disclosure. If it is not specified whether for the stylus and the touch device in traditional use, when touching by the finger and the stylus at the same time the period of the output signal of the stylus and the period of the detection signal of the touch device may overlap, thus causing the interference in the touch device 12 detecting the signal. Such as the dotted line block in the FIG. 2, the time length Tsd of the output signal of the stylus is overlapping with the period of the detection signal of the sensing electrodes TXₙ. Thus, the period and the time length of the signal of the stylus and/or the touch device can be regulated by the synchronization system for the touch detection in the present disclosure.

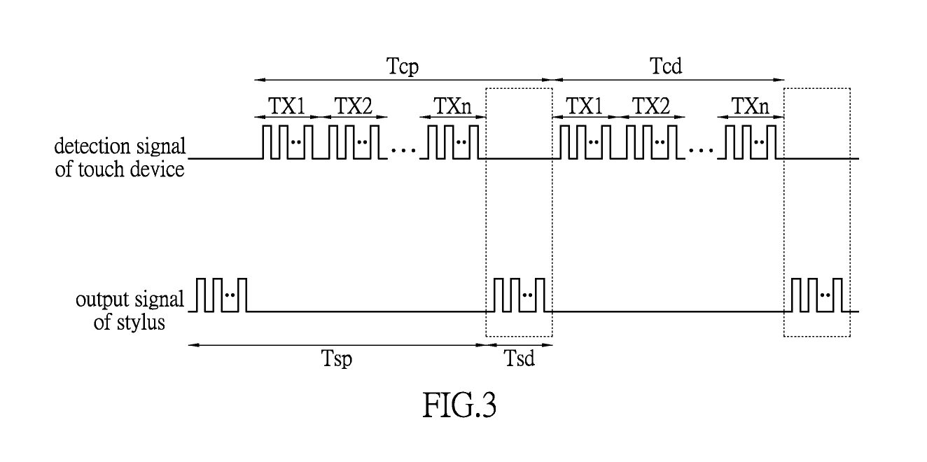

Then, please refer to FIG. 3 in conjunction with FIG. 1 and FIG. 2. FIG. 3 shows a diagram of how the touch device regulates a detection signal according to an output signal outputted from the stylus in the embodiment according to the present disclosure. The micro control unit 123 generates the control signal based on the report rate and the signal-to-noise ratio of the output signal when the touch device 12 receives the output signal outputted from the stylus 11, to control the detection unit 121 to regulate the period Tcp of the detection signal (and/or to regulate the time length Tcd of the detection signal), and thus the output signal of the stylus 11 and the detection signal of the touch device 12 can be staggered. Therefore, the touch device 12 can avoid the interference in detecting the signal. It is worth to note that the touch device 12 only regulates the detection signal according to the output signal of the stylus 11, and does not regulate the output signal of the stylus 11 in the embodiment of the present disclosure. Thus, relying upon the touch device 12 as the main control device to regulate the synchronization system 1 for touch detection.

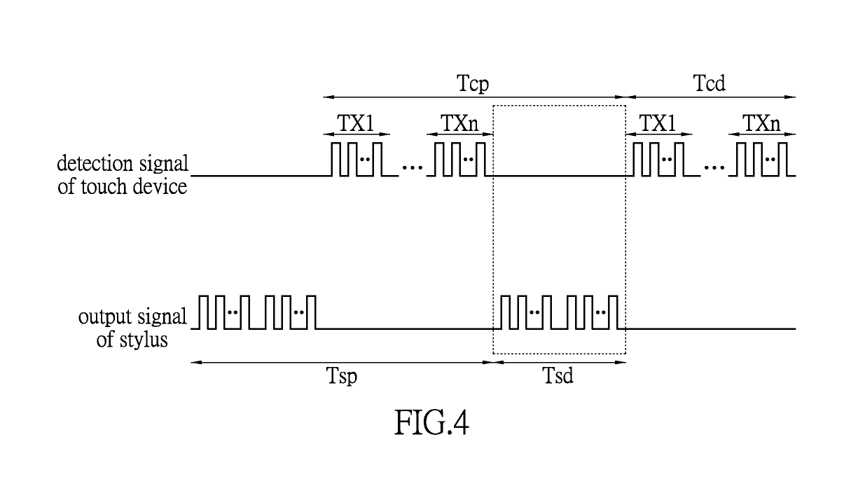

In addition, please refer to FIG. 4 in conjunction with FIG. 1 and FIG. 2. FIG. 4 shows a diagram of how the stylus and the touch device regulate both the output signal and the detection signal in the embodiment according to the present disclosure. The micro control unit 123 generates the regulation signal based on the report rate and the signal-to-noise ratio of the output signal, and transmits the regulation signal to the stylus 11 via the communication unit 122. Then, the micro control unit 113 receives the regulation signal via the communication unit 112, and further controls the signal generator 111 to regulate the period Tsp of the output signal (and/or the time length Tsd of the output signal). Additionally, the micro control unit 123 generates the control signal based on the report rate and the signal-to-noise ratio of the output signal, to control the detection unit 121 to regulate the period Tcp of the detection signal (and/or the time length Tcd of the detection signal), and thus the output signal of the stylus 11 and the detection signal of the touch device 12 can be staggered. Therefore, the touch device 12 can avoid the interference in detecting the signal. The step of the micro control unit 123 generating the regulation signal and the control signal can be performed at the same time; or the micro control unit 123 can generate the regulation signal at first, and then generate the control signal according to the report rate and the signal-to-noise of the output signal generated from the stylus 11. The embodiment of the present disclosure is not limited thereto. In the embodiment of the present disclosure, generally, the calculating/processing capability of the touch device 12 is better than the calculating/processing capability of the stylus 11. Therefore, it is relying upon the touch device 12 as the main control device to detect the performance or generate the regulation signal.

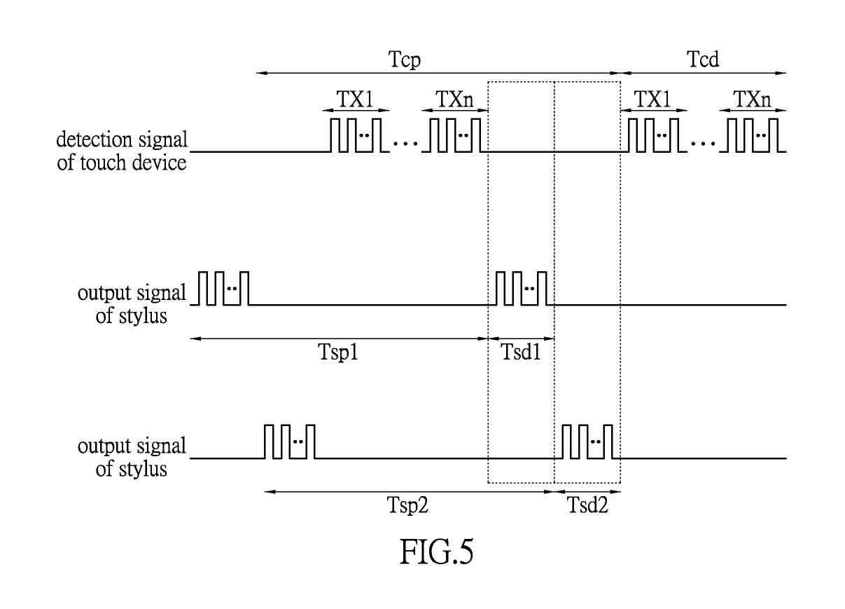

Then, please refer to FIG. 5 in conjunction with FIG. 1 and FIG. 2. FIG. 5 shows a diagram of how the stylus and the touch device regulate both the output signal and the detection signal in another embodiment according to the present disclosure. FIG. 5 further shows the signals of two styluses 11 and the touch device 12. In the embodiment of the present disclosure, the touch device 12 receives the output signals of the two styluses 11. The micro control unit 123 further generates the regulation signal based on the report rate and the signal-to-noise ratio of the output signals respectively, and transmits the output signals back to each stylus 11 via the communication unit 122. More specifically, in the two styluses 11 of the embodiment, the regulation signals include the identification (ID) corresponding to the stylus 11 transmitted from the touch device 12. Thus, each stylus 11 receives the regulation signal including the corresponding identification to control the signal generator 111 to regulate the periods Tsd1/Tsd2 of the output signals (and/or the time length Tsd1/Tsd2 of the output signal). In the embodiment of the present disclosure, although taking two styluses 11 to be illustrated, there also can be three or more styluses implemented, the present disclosure is not limited thereto.

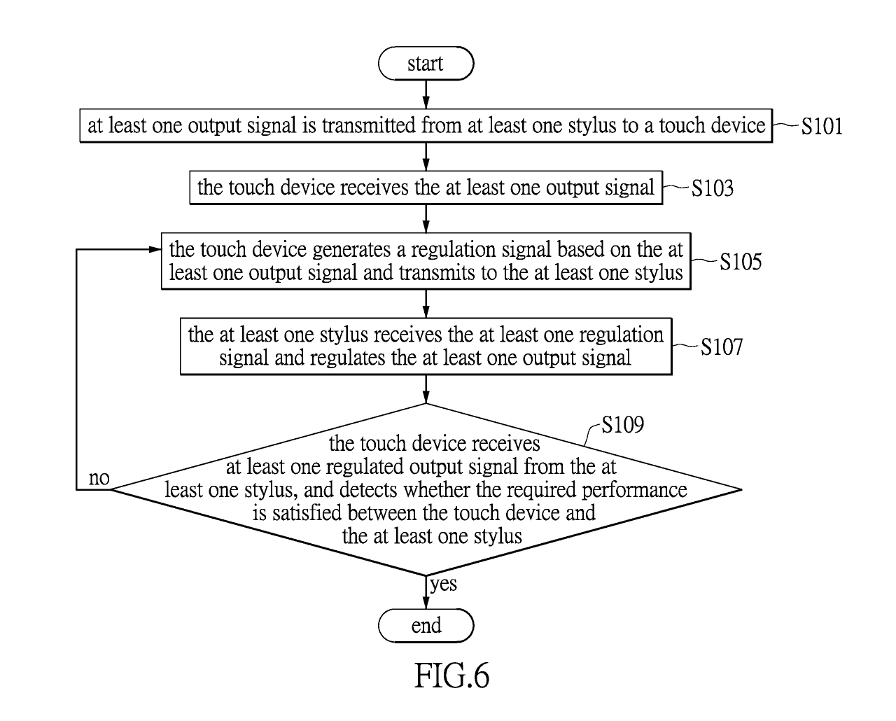

The detailed synchronization flowchart of the stylus and the touch device in the present disclosure is illustrated as follows. Please refer to FIG. 6. FIG. 6 shows a flowchart about the touch device regulating a detection signal according to an output signal outputted from the stylus in the embodiment according to the present disclosure.

Please refer to FIG. 6 in conjunction with FIG. 1. In STEP S101, a signal generator 111 of at least one stylus 11 generates at least one output signal, and transmits the at least one output signal to the touch device 12. Then, in STEP S103, the touch device 12 receives at least one output signal generated by the signal generator 111 of the at least one stylus 11.

In STEP S105, the touch device 12 generates the regulation signal based on the at least one output signal and transmits back to the at least one stylus 11. More specifically, the touch device 12 generates the regulation signal based on the report rate and the signal-to-noise ratio of the at least one output signal. Then, the touch device 12 transmits the regulation signal back to the each stylus 11 via the communication unit 122.

In STEP S107, the at least one stylus 11 receives the regulation signal above via the communication unit 112, and then transmits to the micro control unit 113. The micro control unit 113 further controls the signal generator 111 to regulate the output signal according to the regulation signal. More specifically, the micro control unit 113 controls the signal generator 111 to regulate the report rate and the signal-to-noise ratio of the output signal according to the regulation signal.

In STEP S109, the touch device 12 receives at least one regulated output signal outputted from the at least one stylus 11, and further detects whether a required performance of the synchronization system 1 for touch detection is satisfied. In other word, the touch device 12 further detects whether a required performance is satisfied between the touch device 12 and the at least one stylus 11. If not, go back to STEP S105, and the touch device 12 generates a new regulation signal based on the regulated output signal, and transmits to the each touch stylus 11. If yes, the regulation process is finished.

In the embodiment of the present disclosure, the touch device 12 is to be the main control device. The touch device 12 only regulates the output signal of the at least one stylus 11 with the period of the detection signal of the touch device 12, to achieve the synchronization between the at least one stylus 11 and the touch device 12.

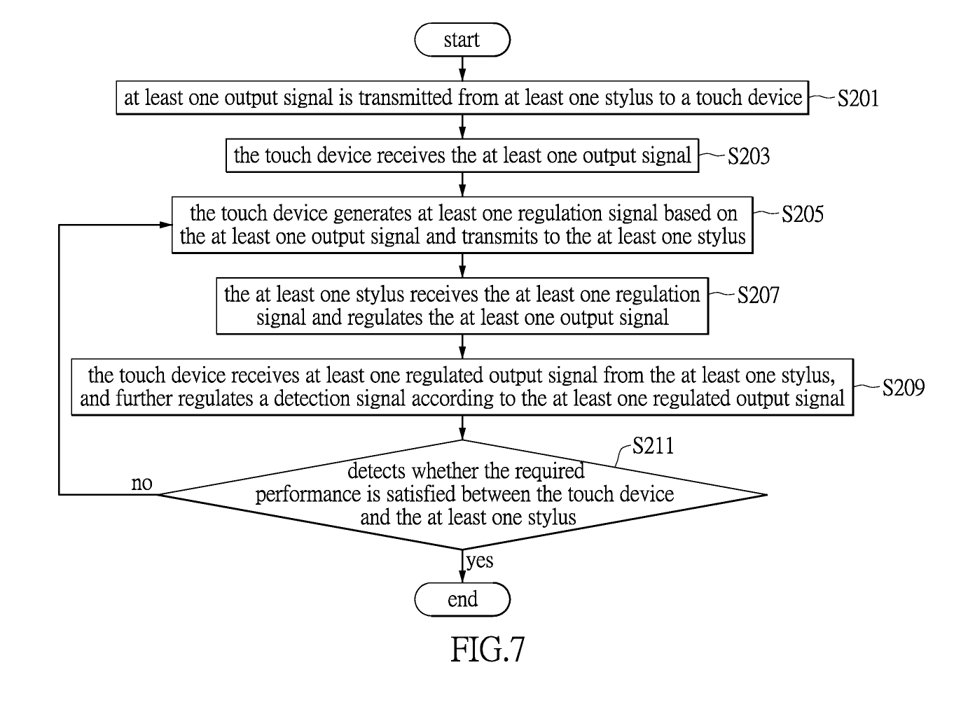

Please refer to FIG. 7 in conjunction with FIG. 5. FIG. 7 shows a flowchart of how the stylus and the touch device regulate both the output signal and the detection signal in the embodiment according to the present disclosure. The STEPs S201-S207, and S211 in the embodiment in FIG. 7 are the same as the STEPs S101-S109 in the embodiment in FIG. 6, so it is omitted hereto.

In STEP S209, the touch device 12 receives at least one regulated output signal by the at least one stylus 11, the micro control unit 123 generates the control signal based on the report rate and the signal-to-noise ratio of the at least one regulated output signal, to control the detection unit 121 to regulate the period Tcp of the detection signal (and/or the time length Tcd of the detection signal) again, thus the output signal of the at least one stylus 11 and the detection signal of the touch device 12 can be staggered. Therefore, the touch device 12 can avoid the interference in detecting the signal, in particular between a plurality of styluses 11 and the touch device 12. Then, the touch device 12 further detects whether a required performance of the synchronization system 1 for touch detection is satisfied. The embodiment of the present disclosure not only regulates the output signal of the at least one stylus 11, but also regulates the detection signal of the touch device 12, and thus raises the efficiency of the whole synchronization system.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A synchronization system for touch detection, comprising:
at least one stylus, comprising:
a signal generator, configured for generating at least one output signal;
a first micro control unit, coupling to the signal generator, configured for controlling the signal generator according to a regulation signal to regulate the at least one output signal; and
a first communication unit, coupling to the first micro control unit, configured for receiving the regulation signal and transmitting to the first micro control unit; and
a touch device, receiving the at least one output signal and generating the regulation signal based on the at least one output signal to transmit to the at least one stylus.

2. The synchronization system according to claim 1, wherein the touch device detects whether a required performance is satisfied between the touch device and the at least one stylus upon the touch device receiving at least one regulated output signal transmitted from the at least one stylus.

3. The synchronization system according to claim 2, wherein the at least one output signal comprises a report rate and a signal-to-ration (SNR).

4. The synchronization system according to claim 3, wherein the touch device comprises:
a detection unit, generating at least one detection signal;
a second communication unit, configured for transmitting the regulation signal; and
a second micro control unit, coupling to the detection unit and the second communication unit, configured for generating the regulation signal and controlling the detection unit to regulate the at least one detection signal.

5. The synchronization system according to claim 4, wherein the second micro control unit generates the regulation signal based on the report rate and the signal-to-noise ratio of the at least one output signal.

6. The synchronization system according to claim 4, wherein the second micro control unit further regulates the at least one detection signal according to the at least one regulated output signal upon the touch device received the at least one regulated output signal transmitted from the at least one stylus.

7. The synchronization system according to claim 4, wherein the first micro control unit is configured for controlling the signal generator to generate a first period and a first time length of the at least one output signal.

8. The synchronization system according to claim 7, wherein the second micro control unit is configured for controlling the detection unit to regulate a second period and a second time length of the at least one detection signal.

9. The synchronization system according to claim 8, wherein the at least second period is greater than the total length summing the first time length and the second time length.

10. The synchronization system according to claim 1, wherein the regulation signal comprises an identification (ID) of the at least one stylus.

11. A synchronization method for touch detection, comprising:
generating at least one output signal by a signal generator of at least one stylus, and transmitting to a touch device;
generating a regulation signal based on the at least one output signal by the touch device and transmitting to the at least one stylus;
transmitting the regulation signal to a first micro control unit of the at least one stylus to control the signal generator, to regulate the at least one output signal; and
receiving regulated at least one output signal outputted from the at least one stylus by the touch device.

12. The synchronization method according to claim 11, wherein upon receiving regulated at least one output signal transmitted from the at least one stylus by the touch device, the touch device further detects whether a required performance is satisfied between the touch device and the at least one stylus.

13. The synchronization method according to claim 12, wherein the at least one output signal comprises a report rate and a signal-to-noise ratio.

14. The synchronization method according to claim 13, wherein before the touch device detects whether the required performance is satisfied between the touch device and the at least one stylus, a second micro control unit of the touch device controls a detection unit of the touch device to regulate at least one detection signal.

15. The synchronization method according to claim 14, wherein the second micro control unit generates the regulation signal based on the report rate and the signal-to-noise ratio of the at least one output signal.

16. The synchronization method according to claim 14, wherein the first micro control unit controls the signal generator to generate a first period and a first time length of the at least one output signal.

17. The synchronization method according to claim 16, wherein the second micro control unit controls the detection unit to generate a second period and a second time length of the at least one detection signal.

18. The synchronization method according to claim 17, wherein the second period is greater than the total length summing the first time length and the second time length.

19. A stylus adapted for a touch device, comprising:
a signal generator, configured for generating at least one output signal;
a micro control unit, coupling to the signal generator, configured for controlling the signal generator according to a regulation signal to regulate the at least one output signal; and
a communication unit, coupling to the micro control unit, configured for receiving the regulation signal and transmitting to the micro control unit;
wherein the touch device receives the at least one output signal and generates the regulation signal based on the at least one output signal to transmit to the at least one stylus.

20. The stylus according to claim 19, wherein the stylus is an active stylus including a battery unit.
